(19) United States
(12) Patent Application Publication
(10) Pub. No.: US 2021/0383300 A1
(43) Pub. Date: Dec. 9, 2021

(54) MACHINE LEARNING BASED APPLICATION FOR THE INTELLIGENT ENTERPRISE

(71) Applicant: SAP SE, Walldorf (DE)

(72) Inventors: Steffen Vollmert, Frankfurt (DE); Jean-Philippe Lombardi, Heidelberg (DE)

(21) Appl. No.: 16/897,089

(22) Filed: Jun. 9, 2020

(51) Int. Cl. G06Q 10/06; G06N 20/00; G06F 16/9035; G06F 3/0482

(52) U.S. Cl. CPC G06Q 10/06315; G06F 3/0482; G06F 16/9035; G06N 20/00

(57) ABSTRACT

Methods, systems, and articles of manufacture are provided for focusing data. In some implementations, there may be provided sending a query for report data in response to a first selection of a report and a second selection of a machine learning model, the query including an identifier of the report and an indication of the machine learning model, the machine learning model trained to focus a structure of the report data for the report; in response to detecting the indication, processing, by the machine learning model, the report data to sort and focus the report data, the report data being responsive to the query of a database; and providing the processed report data to a user interface for display to a user, the report data structured to include the focus provided by the machine learning model. Related systems and articles of manufacture, including computer program products, are also provided.

### BACKGROUND

Many organizations may rely on enterprise software applications including, for example, enterprise resource planning (ERP) software, customer relationship management (CRM) software, and/or the like. These enterprise software applications may provide a variety of functionalities including, for example, invoicing, procurement, payroll, time and attendance management, recruiting and onboarding, learning and development, performance and compensation, workforce planning, and/or the like. Some enterprise software applications may be hosted by a cloud-computing platform such that the functionalities provided by the enterprise software applications may be accessed remotely by multiple end users. For example, an enterprise software application may be available as a cloud-based service including, for example, a software as a service (SaaS) and/or the like.

### SUMMARY

Methods, systems, and articles of manufacture, including computer program products, are provided for focusing data. In some implementations, there may be provided a method including sending a query for report data in response to a first selection of a report and a second selection of a machine learning model, the query including an identifier of the report and an indication of the machine learning model, the machine learning model trained to focus a structure of the report data for the report; in response to detecting the indication, processing, by the machine learning model, the report data to sort and focus the report data, the report data being responsive to the query of a database; and providing the processed report data to a user interface for display to a user, the report data structured to include the focus provided by the machine learning model.

In some variations, one or more of the features disclosed herein including the following features can optionally be included in any feasible combination. A client device may present a first user interface, the first user interface including a report selection user interface element to enable selection of the report from a plurality of reports and further including a model selection user interface element to enable selection of the machine learning model from a plurality of machine learning models. The first selection of the report and the second selection of the machine learning model may trigger the sending of the query. The plurality of machine learning models may be mapped to the report. The first selection of the report may cause the plurality of machine learning models to be provided to the client device for the presenting at the model selection user interface element. Each of the plurality of machine learning models may be trained to provide a different focus for the report data for the report. The client device may present a second user interface, the second user interface including a listing of the plurality of machine learning models and further including, for each of the plurality of machine learning models, a first user interface element to enable defining whether the corresponding machine learning model is public or private and a second user interface element to enable defining a refresh cycle for the corresponding machine learning model. The focus provided by the machine learning model may include ranking the report data. The machine learning model may be trained to learn to rank the report data.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to the virtualization of configuration data, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts example of user interfaces, in accordance with some example embodiments;

FIG. 1B depicts an example of a machine learning model trained to output data in a structure that is focused, in accordance with some example embodiments;

FIG. 1C depicts an example of a system including a focus group builder, in accordance with some example embodiments;

FIG. 2 depicts a machine learning model accessing data, in accordance with some example embodiments;

FIG. 3 depicts an example of a user interface in which a user can define an ML model, in accordance with some example embodiments;

FIG. 4 depicts a process for focusing data, in accordance with some example embodiments; and

FIG. 5 depicts a block diagram illustrating a computing system, in accordance with some example embodiments.

When practical, like labels are used to refer to same or similar items in the drawings.

### DETAILED DESCRIPTION

In some computer systems, such as complex database systems, enterprise resource planning (ERP) systems, and the like, a user may query a backend database for data and the backend database responds with a query result which may be formatted into a report. This response, such as the report, may appear as a user interface view on a display so the user can view the report. Often, the user receives the response sorted in some arbitrary or default format. For example, a user may query a backend database to provide a report on all current customers, and that report may be sorted by customer ID. If, however, the user has a specific objective for the report in mind, such as provide a “rebate” to each customer, then the sorting by customer ID may provide data that is not focused. In some embodiments, there is provided a way to focus the data returned in a report so that it is focused on the user's objective for the report.

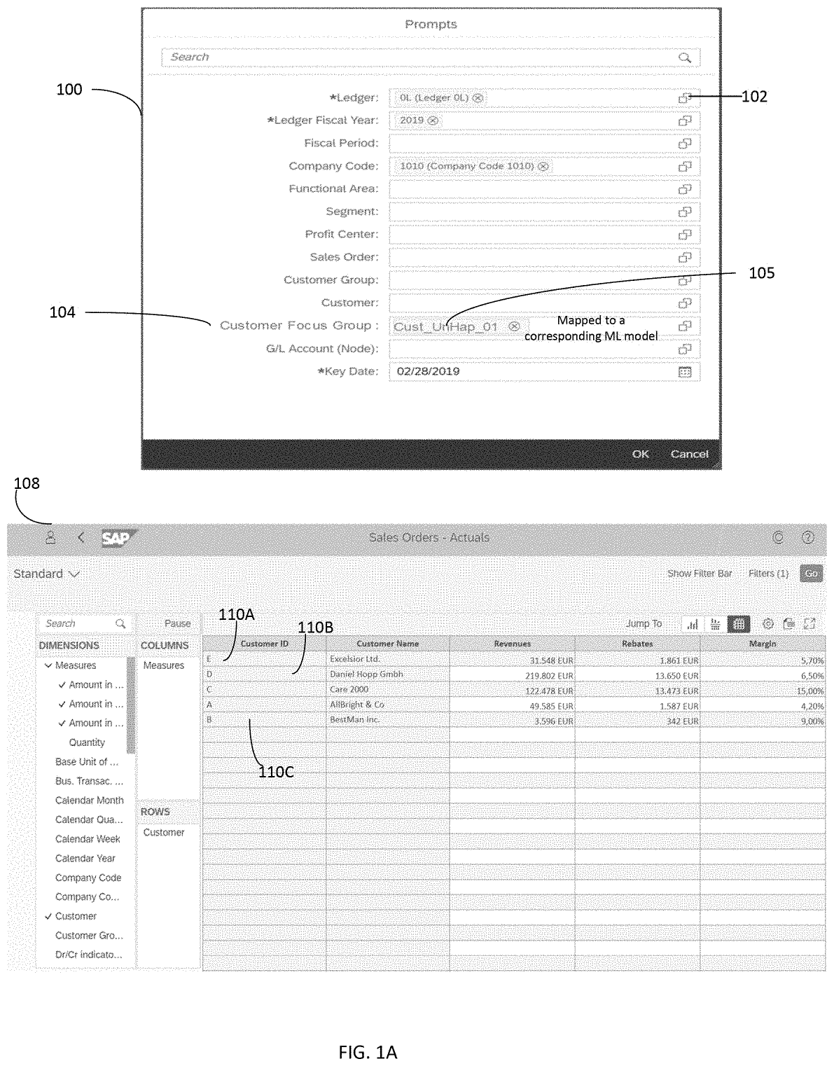

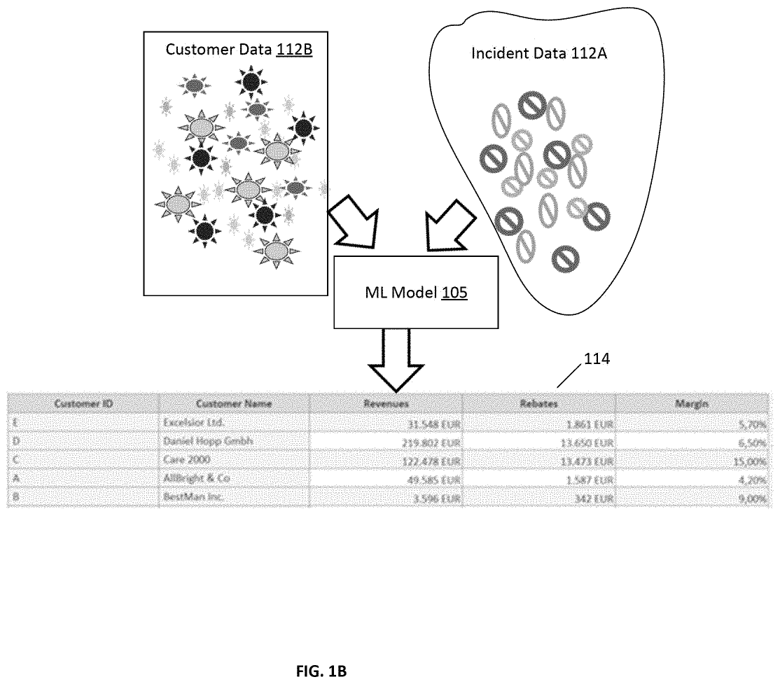

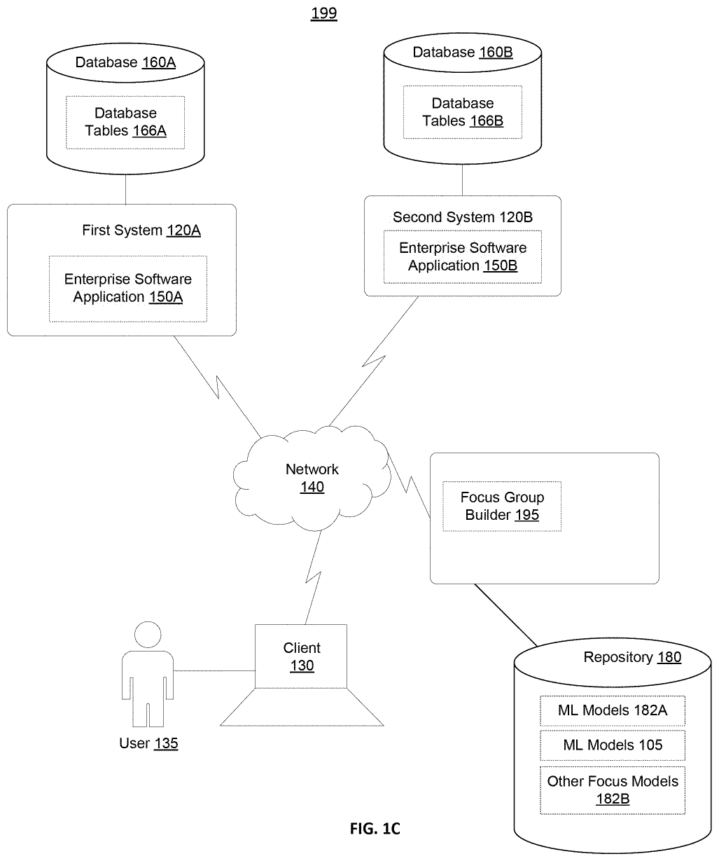

FIG. 1A depicts a user interface 100 which may be presented at a client device. In this example, the user interface allows selection of a type of report 102 as well as other aspects of the report (e.g., ledger fiscal year, fiscal period, company code, functional area, segment, profit center, sales order, customer group, customer, account, key date, etc.). In some embodiments, the user interface 100 includes a user interface element 104 where a focus group, such as unhappy customers (e.g., “Cust_Unhap_01”), can be selected from among one or more focus groups.

The selected focus group, which in this example is unhappy customers, enables the data for the report select at 102 to be structured so that the data is focused based on which customers are unhappy. To illustrate further, the selection of Cust_Unhap_01 at 104 causes a machine learning model 105 to be selected (which is mapped or associated with the Cust_Unhap_01). When the data for the report is queried and returned, the data for the report is focused (e.g., filtered, sorted, structured, and/or the like) by the machine learning model 105 so that unhappy customers are the focus of the report.

In the example of FIG. 1A, the machine learning model focuses the data for the report so that unhappy customers are ranked at the top of the report shown at user interface 108. For example, the customer E 110A is at the top of the report as the most unhappy customer, customer D 110B is the second unhappiest customer, and so forth down to customer B 110C. In this way, the report is focused on the objective of the report. Returning to the previous example, the report enables the user to provide “rebates” to the unhappiest customers.

Although the previous example depicts providing focus via sorting the unhappiest customers at the top of the list, the ML model may structure the report in other ways to focus the report per the selection at 104 (which in this example is unhappy customers). For example, the ML model may filter (e.g., remove) customers that are not considered unhappy (e.g., customers below a threshold level of unhappiness are considered happy and thus not presented or included in the report). Other ways the ML may focus the report include visual indications such as highlighting, haptics (e.g., vibrations), and the like. Furthermore, the listing 114 focused by the ML model may be used as a report as shown at FIG. 1B, although it may be used for other purposes (e.g., provided as an input to another process).

In some embodiments, the ML model 105 (which is selected at via the user interface element 104) is trained to focus the data in the report. FIG. 1B depicts an example of an ML model, such as the ML model 105 selected at FIG. 1A. In this example, the ML model 105 may implemented as a neural network trained to identify, sort, and rank unhappy customers. In the example of FIG. 1B, the ML model is trained using input data. The input data may include data such as customer data 112B (which may be stored in databases 160A-160B as described below with respect to FIG. 1C) and incident data 112A, such as errors, product returns, call center complaints, and/or other data indicative of a customer that might not be satisfied with a service or product being provided (which may also be stored in databases 160A-160B as described below with respect to FIG. 1C).

For example, the ML model 105 may be trained so that it learns how to rank customers as unhappy based on incident data 112A as well as other data 112B. In some embodiments, the ML model classifies customers as either happy or unhappy and/or rank customers based on a relative level of unhappiness. In some implementations, the ML model may classify a customer as unhappy based on a distance measurement to a cluster (or group) of other unhappy customers. In this example, customers within a threshold distance to the cluster are classified as unhappy, and the threshold distance may also be used for the ranking (e.g., the shorter the threshold distance to the cluster center of unhappy customers, the unhappier the customer). Once the ML model is trained, the ML model may provide as an output 114 a ranked list of customer IDs given an input, such as customer data and incident data, which may be obtained from a backend database, for example.

Referring again to FIG. 1A, there may be a plurality of focus groups that can be selected at 104/105 to focus the results of the report. Moreover, each focus group listed at 104/105 may have a corresponding ML model to focus the report data, which may be obtained from a backend database such as database 160A or B depicted at FIG. 1C for example. To illustrate further, each of the ML models may have a different focus. For example, an inventory loss report on goods may focus, based on a first ML model selected at 104, the report on transport carriers for which there is little history of performance; an expense claims report on employees may focus, based on a second ML model selected at 104, on employees who have had errors or returned expense reports; and so forth. In all of these examples, the user may select, for a given report, the focus by selecting a different ML model selected at 104, so the focus is user selected for each report as shown at FIG. 1A, for example.

Although the previous example describes all of selections at 105 from among a group of ML models, some of the models may have other forms. For example, the selection at 105 may include (1) a user defined model which may include script, code, or other instructions provided by the user to focus the report, (2) a pre-determined or a default model provided by a third party or the developer of the database of enterprise software, and/or (3) other types of models.

FIG. 1C depicts an example of a system 199 including a focus group builder 195, in accordance with some example embodiments. The focus group builder 195 may focus the data provided to a client device in a report so that the data is focused in a user-selected manner.

The system 199 may further include a first system 120A, which hosts an application such as an enterprise software application 150A. The system 199 may also include a second system 120B, which hosts an application such as an enterprise software application 150B. The enterprise software applications 150A may access data stored in database tables 166A at database 160A, and the enterprise software applications 150B may access data stored in database tables 166B at database 160B. The system 199 may also include a client 130.

As shown in FIG. 1C, the focus group builder 195, the first system 120A, the second system 120B, and the client 130 may be coupled by a network 140. The network 140 may be a wired and/or wireless network including, for example, a wide area network (WAN), local area network (LAN), a virtual local area network (VLAN), the Internet, and/or the like. Moreover, the first system 120A and/or the second system 120B may be a cloud-based system hosted on a cloud-computing platform, although the first system and/or the second system may be located on premises as well.

Examples of the enterprise software applications 150A-B may include an enterprise resource planning (ERP) software application, a customer relationship management (CRM) software application, a supply chain management (SCM) software application, and/or the like. Accordingly, the enterprise software application may perform a variety of functions including, for example, procurement, invoicing, payroll, time and attendance management, recruiting and onboarding, learning and development, performance and compensation, workforce planning, and/or the like.

The focus group builder 195 may be coupled to a repository 180 including a plurality of ML models 182 including ML model 105. The repository may also include other models, such as user defined models, pre-determined models, default models, and/or the like. The focus group builder 195 provides the one or more models to be listed as a drop down (or, for example, in other ways) at user interface 100 at user interface element 104, so a model such as ML model 105 can be selected from among other different ML models for focusing the report.

Although the focus group builder 195 is depicted separate from the client device 130, in some embodiments the focus group builder 195 may be comprised in the client device 130. For example, the enterprise software application 150A may provide, in response to the query request from the client device 130, a response including data for a report. And, this response including the data may be processed at the client device to provide the report focused by the focus group builder 195 including the selected ML model. Alternatively, the focus group builder 195 may be comprised in the system 120A or 120B. For example, the response to the query for a report may be processed at the system 120A to provide the report in a focused form per the ML model 105 of the focus group builder.

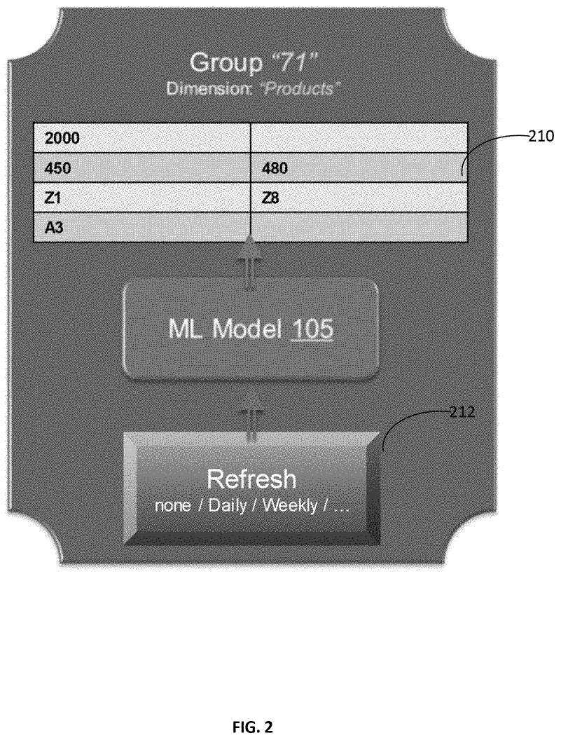

FIG. 2 depicts an example of ML model 105 accessing (e.g., receiving or retrieving) data 210 in a database table, such as database table 166A or 166B) to sort the data in a focused way based on the user's concurrent selection of the report 102 and the ML model 105 (as shown at FIG. 1A, for example). As noted, although the ML model 105 is shown at FIG. 2, other types of models which may be defined by a user, pre-determined, default, or other types of report model structures may be used as well to focus the data being provided in the report.

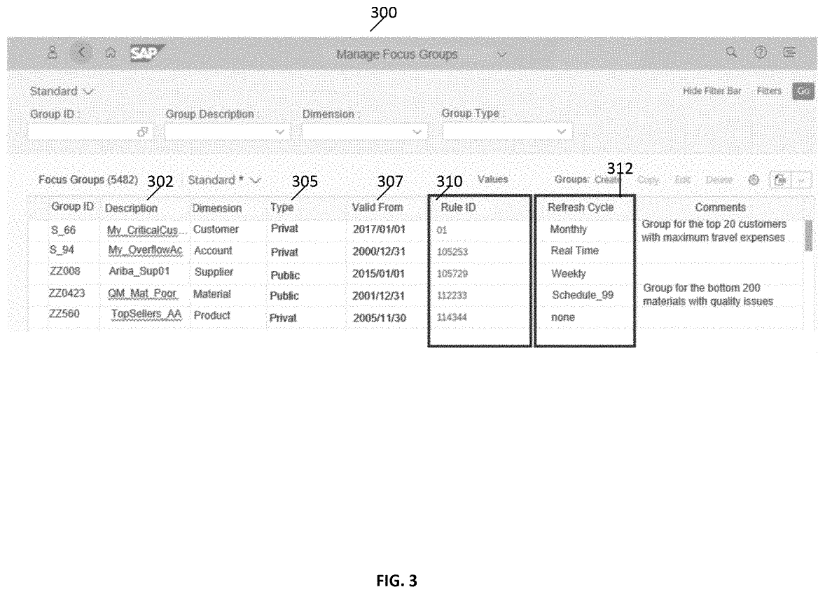

FIG. 3 depicts an example of a user interface 300 at which a user can manage the ML models used to focus the data in one or more reports. For example, the user interface may include a list 302 of ML models available to the user. The user interface 300 may also be used to define whether a focus group is private or public 305. For example, a private group is only for the use by a certain user, while a public model may be shared among users. Furthermore, the user interface 300 may also allow the user to define dates 307 for which a model is valid and rule identifiers 310 for each model. Moreover, the user interface 300 may also allow the user to define a refresh cycle 312. For example, the listing at 114 of unhappy customers may be refreshed from time to time. The frequency of updating may be dictated by a refresh cycle (e.g., hourly, daily, weekly, monthly, or other time frame), on-demand when the data is requested, or triggered by an event such as a threshold value being attained (e.g., sales revenue decreasing below a threshold triggers an update of the unhappy customers at 114). The definition defined from the models at 300 may be stored in repository 180.

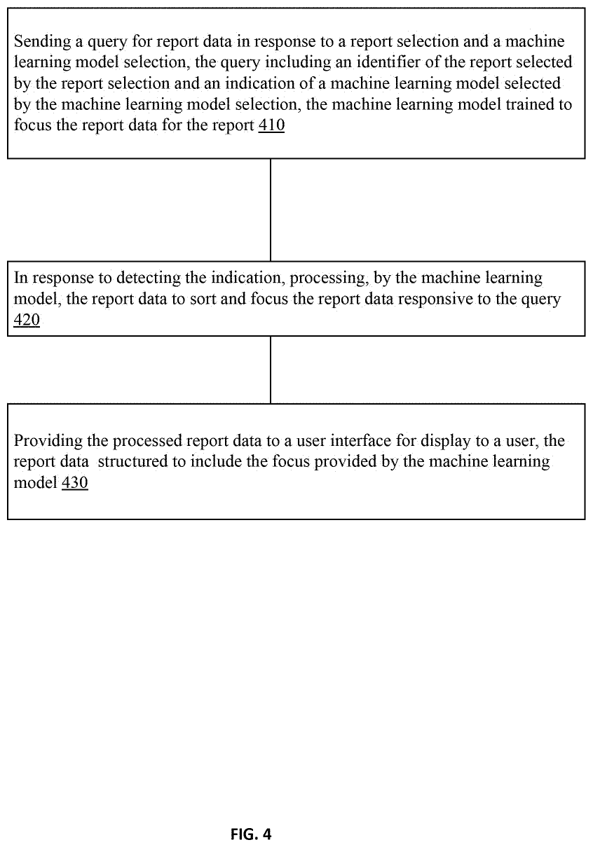

FIG. 4 depicts an example of a process 400 for focusing the data for a report based on a machine learning model provided structure for the report that focuses the report.

At 410, a request for a query may be sent in response to a report request. For example, a user interface at client device 130 may send a query via network 140 to system 120A including enterprise software application 150A. This query may ask for a report or data for a report to be viewed. The query may include the (1) identifier of the report being requested, such as “OL (Ledger OL)” 102 (FIG. 1A) and (2) an indication (e.g., an indication that ML model 105 is selected at 104) that a focus group has been selected for this specific report.

For example, the client device 130 may present or display a first user interface, such as user interface 100. This user interface 100 may include a report selection, such as a drop down where OL_Ledger 102 is selected from among a plurality of reports. The user interface 100 may also include a model selection, such as a drop down where Cust_Unhap_01 105 is selected. This focus group selection such as Cust_Unhap_01 may map to, or represent, a corresponding machine learning model 105 for focusing the report data. Moreover, the drop down at 104 may list a plurality of focus groups which can be selected. Each of these focus groups may be mapped to, or indicative of, a ML model for focusing the report data in a different way. And, each of the ML models may be mapped to a report. As noted, each of the ML models may provide a different focus for the report data for the report.

In some embodiments, when the report selection is made at 102, the focus group builder 195 retrieves from the repository 180 a plurality of ML models which can be used with the selected report. In some embodiments, the retrieved ML models may include public ML models and private ML models (defined as private for the user's use).

If the report has been associated with a focus group or ML model, the report data returned in response to the query is processed, at 420, by the focus group builder and in particular a ML model 105. For example, if the query includes the indication (e.g., an indication that ML model 105 is selected at 104) that the focus group (or ML model) has been selected for the report, the focus group builder 195 can intercept the query results (e.g., responsive report data from the first system 120A or corresponding database 160A) and then format the data in accordance with the ML model 105 selected at 104. The ML model 105 (which has been trained as noted herein) may receive as an input the data for the requested report and output the focused report data. FIG. 1B at 114 and FIG. 1A at 108 (see 110A-C) depict examples where the ML model focuses the report including the data so that the unhappy customers are listed first in the report. To illustrate further, the focus group builder may monitor or otherwise receive queries which are detected as having an indication of a ML model being selected to focus the report data.

After the ML model has processed the data to structure the data so the focus is in accordance with the focus group (or ML model) selected by the user, the data is then provided, at 430, to a user interface and presented in a report for display to a user. For example, the data output from the ML model may be provided in focused form as shown at 108 (FIG. 1A) for example, to user interface 108 at client device 130.

In some example embodiments, the ML model may be implemented as a neural network. However, it should be appreciated that the ML model may be implemented as any type of machine learning model including, for example, a regression model, regression training, an instance-based model, a long short-term memory neural network, a regularization model, a decision tree, a random forest, a Bayesian model, a clustering model, an associative model, a deep learning model, an autoencoder, a dimensionality reduction model, an ensemble model, and/or the like. The ML model may be trained using supervised learning or unsupervised learning. The training data may be obtained by sampling data in the databases of the first or second systems. The ML model may be recursively trained until it learns to generate a desired output, such as structure the data in the report according to a desired focus, given sample input data. Given a new input, the trained ML model may provide a desired output.

In some embodiments, a first user interface may be generated. For example, the client device may generate the first user interface including a report selection user interface element to enable selection of the report from a plurality of reports and further including a model selection user interface element to enable selection of the machine learning model from a plurality of machine learning models. In some embodiments, a second user interface may be generated. For example, the client device may generate a second user interface including a listing of the plurality of machine learning models and further including, for each of the plurality of machine learning models, a first user interface element to enable defining whether the corresponding machine learning model is public or private and a second user interface element to enable defining a refresh cycle for the corresponding machine learning model.

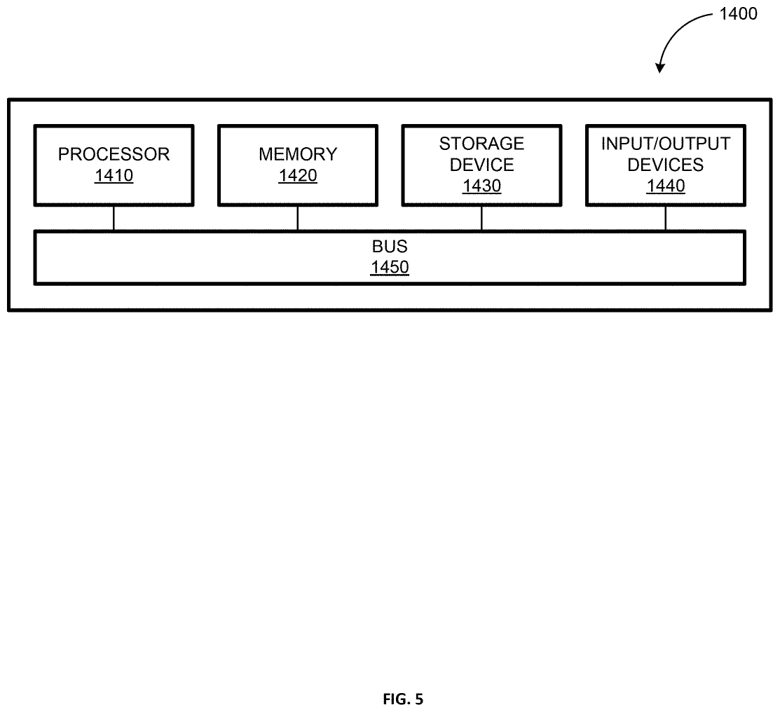

FIG. 5 depicts a block diagram illustrating a computing system 4100 consistent with implementations of the current subject matter. Referring to FIGS. 1-4, the computing system 1400 can be used to implement the focus group builder 195 and/or any components depicted at FIG. 1B, for example. As shown in FIG. 5, the computing system 1400 can include a processor 1410, a memory 1420, a storage device 1430, and input/output devices 1440. The processor 1410, the memory 1420, the storage device 1430, and the input/output devices 1440 can be interconnected via a system bus 1450. The processor 1410 is capable of processing instructions for execution within the computing system 1400. Such executed instructions can implement one or more components of, for example, the activation engine 199. In some implementations of the current subject matter, the processor 1410 can be a single-threaded processor. Alternately, the processor 1410 can be a multi-threaded processor. Alternately, or additionally, the processor 1410 can be a multi-processor core. The processor 1410 is capable of processing instructions stored in the memory 1420 and/or on the storage device 1430 to display graphical information for a user interface provided via the input/output device 1440.

The memory 1420 is a computer readable medium such as volatile or non-volatile that stores information within the computing system 1400. The memory 1420 can store data structures representing configuration object databases, for example. The storage device 430 is capable of providing persistent storage for the computing system 400. The storage device 1430 can be a solid-state device, a floppy disk device, a hard disk device, an optical disk device, a tape device, and/or any other suitable persistent storage means. The input/output device 1440 provides input/output operations for the computing system 1400. In some implementations of the current subject matter, the input/output device 440 includes a keyboard and/or pointing device. In various implementations, the input/output device 1440 includes a display unit for displaying graphical user interfaces.

According to some implementations of the current subject matter, the input/output device 1440 can provide input/output operations for a network device. For example, the input/output device 1440 can include Ethernet ports or other networking ports to communicate with one or more wired and/or wireless networks (e.g., a local area network (LAN), a wide area network (WAN), the Internet).

In some implementations of the current subject matter, the computing system 1400 can be used to execute various interactive computer software applications that can be used for organization, analysis and/or storage of data in various (e.g., tabular) format (e.g., Microsoft Excel®, and/or any other type of software). Alternatively, the computing system 1400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided via the input/output device 1440. The user interface can be generated and presented to a user by the computing system 1400 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one data processor; and
at least one memory storing instructions, which when executed by the at least one data processor, result in operations comprising:
sending a query for report data in response to a first selection of a report and a second selection of a machine learning model, the query including an identifier of the report and an indication of the machine learning model, the machine learning model trained to focus a structure of the report data for the report;
in response to detecting the indication, processing, by the machine learning model, the report data to sort and focus the report data, the report data being responsive to the query of a database; and
providing the processed report data to a user interface for display to a user, the report data structured to include the focus provided by the machine learning model.

2. The system of claim 1, further comprising:
presenting, at a client device, a first user interface, the first user interface including a report selection user interface element to enable selection of the report from a plurality of reports and further including a model selection user interface element to enable selection of the machine learning model from a plurality of machine learning models.

3. The system of claim 2, wherein the first selection of the report and the second selection of the machine learning model trigger the sending of the query.

4. The system of claim 2, wherein the plurality of machine learning models are mapped to the report.

5. The system of claim 2, wherein the first selection of the report causes the plurality of machine learning models to be provided to the client device for the presenting at the model selection user interface element.

6. The system of claim 5, wherein each of the plurality of machine learning models are trained to provide a different focus for the report data for the report.

7. The system of claim 2, further comprising:
presenting, at the client device, a second user interface, the second user interface including a listing of the plurality of machine learning models and further including, for each of the plurality of machine learning models, a first user interface element to enable defining whether the corresponding machine learning model is public or private and a second user interface element to enable defining a refresh cycle for the corresponding machine learning model.

8. The system of claim 1, wherein the focus provided by the machine learning model comprises ranking the report data.

9. The system of claim 8, wherein the machine learning model is trained to learn to rank the report data.

10. A method comprising:
sending a query for report data in response to a first selection of a report and a second selection of a machine learning model, the query including an identifier of the report and an indication of the machine learning model, the machine learning model trained to focus a structure of the report data for the report;
in response to detecting the indication, processing, by the machine learning model, the report data to sort and focus the report data, the report data being responsive to the query of a database; and
providing the processed report data to a user interface for display to a user, the report data structured to include the focus provided by the machine learning model.

11. The method of claim 10, further comprising:
presenting, at a client device, a first user interface, the first user interface including a report selection user interface element to enable selection of the report from a plurality of reports and further including a model selection user interface element to enable selection of the machine learning model from a plurality of machine learning models.

12. The method of claim 11, wherein the first selection of the report and the second selection of the machine learning model trigger the sending of the query.

13. The method of claim 11, wherein the plurality of machine learning models are mapped to the report.

14. The method of claim 11, wherein the first selection of the report causes the plurality of machine learning models to be provided to the client device for the presenting at the model selection user interface element.

15. The method of claim 14, wherein each of the plurality of machine learning models are trained to provide a different focus for the report data for the report.

16. The method of claim 11, further comprising:
presenting, at the client device, a second user interface, the second user interface including a listing of the plurality of machine learning models and further including, for each of the plurality of machine learning models, a first user interface element to enable defining whether the corresponding machine learning model is public or private and a second user interface element to enable defining a refresh cycle for the corresponding machine learning model.

17. The method of claim 11, wherein the focus provided by the machine learning model comprises ranking the report data.

18. The method of claim 17, wherein the machine learning model is trained to learn to rank the report data.

19. A non-transitory computer-readable storage medium including program code which when executed by at least one data processor causes operations comprising:
sending a query for report data in response to a first selection of a report and a second selection of a machine learning model, the query including an identifier of the report and an indication of the machine learning model, the machine learning model trained to focus a structure of the report data for the report;
in response to detecting the indication, processing, by the machine learning model, the report data to sort and focus the report data, the report data being responsive to the query of a database; and
providing the processed report data to a user interface for display to a user, the report data structured to include the focus provided by the machine learning model.

20. The non-transitory computer-readable storage medium of claim 19, further comprising:
presenting, at a client device, a first user interface, the first user interface including a report selection user interface element to enable selection of the report from a plurality of reports and further including a model selection user interface element to enable selection of the machine learning model from a plurality of machine learning models.
